(19) United States
(12) Patent Application Publication
(10) Pub. No.: US 2026/0281133 A1
(43) Pub. Date: Sep. 17, 2026

(54) System and method for detecting and mitigating malicious network traffic

(71) Applicant: Bank of America Corporation, Charlotte, NC (US)

(72) Inventors: Steven E. Sinks, Scottsdale, AZ (US); Joshua Abraham, Sharon, MA (US)

(21) Appl. No.: 19/079,659

(22) Filed: Mar. 14, 2025

(51) Int. Cl. H04L 9/40

(52) U.S. Cl. CPC H04L 63/1425; H04L 63/0236; H04L 63/1416

(57) ABSTRACT

A system for detecting and mitigating anomalous network traffic is disclosed. The system receives traffic data with respect to a computing device and parses the traffic data to identify network attributes from the traffic data. The system generates baseline traffic data based on the network attributes, where the baseline traffic data indicates an expected pattern of network communication of the computing device. The system detects current traffic data with respect to the computing device. The system parses the current traffic data to identify network attributes of the current traffic data. The system determines whether the current traffic data deviates from the baseline traffic data by comparing the network attributes of the baseline with the counterpart network attributes of the current traffic data. If it is determined that the current traffic data deviates from the baseline traffic data, the system determines that the current traffic data is anomalous.

### TECHNICAL FIELD

The present disclosure relates generally to network security, and more specifically to a system and method for detecting and mitigating malicious network traffic.

### BACKGROUND

Within an organization, computing devices are used to communicate data to other devices. Organizations implement firewalls to monitor the network traffic of the computing devices.

### SUMMARY

The disclosed system, described in the present disclosure, is particularly integrated into practical applications to provide technological improvements to conventional network anomaly detection techniques.

Conventional systems typically implement firewall policies to monitor network traffic at an organization level network. However, the conventional systems suffer from several drawbacks. For example, the firewall policies are static and solely based on a preconfigured, fixed list of authorized network addresses (e.g., Internet protocol (IP) addresses) and blocked network addresses. Thus, conventional systems fail to detect dynamic new security breaches that are not previously indicated in the static firewall policies. In another example, the conventional systems monitor network traffic at the organization level, as opposed to at each computing device level, and therefore, fail to detect security breaches made from a previously authorized computing device (and/or previously authorized user credentials) within the organization. In other words, the conventional systems monitor the incoming and outgoing communication with respect to the organization's network, rather than monitoring the internal network traffic at the individual computing device level. Conventional systems are not configured to distinguish network traffic across different computing devices within an organization or have distinguishing network policies for different computing devices within an organization. Further, the conventional systems would not suspect that a network activity from a previously authorized computing device is malicious. Thus, if a bad actor gains access to a previously authorized computing device within the organization-whether through stolen user credentials, malware, or insider threats-the conventional systems fail to detect unauthorized activity originating from that computing device. Therefore, the drawbacks in the conventional systems lead to the bad actor being able to use the computing device to perform malicious operations, including but not limited to, installing or deploying malware, data exfiltration, data destruction, and data manipulation, among others. Further, the drawbacks of the conventional system further lead to data stored in some or all of the computing devices within the organization being compromised as the bad actor can access that data via the previously authorized computing devices and/or previously authorized user credentials. For example, sensitive or confidential data, such as personal information and information about operations of the organization may be compromised.

The disclosed system is configured to provide a technological solution to these and other technical problems in the conventional network anomaly detection techniques. The technical advantages and improvements over the conventional techniques are described below in conjunction with certain embodiments of the disclosed system.

In some embodiments, the disclosed system is configured to implement network anomaly monitoring and detection at the computing device level-which is more granular compared to the conventional systems that implement network traffic monitoring at the organization level. This, in turn, leads to the disclosed system detecting malicious network activity originating from a previously authenticated host computing device and/or authenticated user credential that the conventional systems would fail to detect. The disclosed system establishes a baseline traffic data for each host computing device, where the baseline traffic data associated with a given host computing device indicates an expected network communication pattern between the given host computing device and other devices. The disclosed system determines whether any new traffic data of the host computing device deviates from its respective baseline traffic data. If it is determined that the new traffic data deviates from the baseline traffic data, the disclosed system determines that a bad actor (e.g., an inside traitor) is engaging in or conducting a malicious network activity, such as installing an unknown or not authorized application (such as malware), executing an unknown or not authorized code (such as via command prompt), initiating an unauthorized network communication, data exfiltration, and the like. The conventional systems would have failed to detect such malicious network activities because of their preconfigured firewall policy assuming that the host computing device and/or the user credential used to access that host computing device is/are trusted. In response to detecting that the new traffic data deviates from the baseline traffic data, the disclosed system is configured to detect anomalous/malicious network activity and mitigate it. In some examples, the disclosed system is configured to identify, isolate, and quarantine data packets associated with the detected malicious network activity. Thus, the malicious data packets are contained and not spread through systems and the organization. For example, upon detecting that a network packet is associated with a malicious network activity, the disclosed system may transfer the network packet to a quarantine sector within the memory of the server. The quarantine sector is a designated memory space that isolates the malicious network packet from the rest of the system to prevent the malicious network packet from interacting with other components and systems. Once the network packet is transferred into the quarantine sector, the disclosed system may perform an analysis to determine the nature and extent of the malicious activity. In this process, the disclosed system may scan the network packet against a database of known malicious patterns. If the network packet is associated with a known malicious pattern, the disclosed system may mitigate the security threat by either discarding the network packet or modifying its content to generate a sanitized version of the network packet before determining whether to allow or deny its transmission. In this manner, the disclosed system mitigates the spread of malicious network activity by physically isolating suspicious or malicious network packets before they can propagate within the network or compromise other computing devices.

In some examples, the disclosed system is configured to communicate alert messages that indicate the detected malicious network activity. Thus, the disclosed system is configured to proactively mitigate malicious network activities originating from a previously authorized computing device and/or via authorized user credentials. Therefore, the disclosed system reduces the probability of malicious activities described above, such as data exfiltration, data destruction, and data manipulation, among others. In particular, reducing the probability of malicious activities leads to technical benefits, such as protecting sensitive data from unauthorized access, which can increase the accuracy and consistency of stored data by preventing unauthorized modifications and can also help against the loss of data due to data exfiltration. Other technical benefits include minimizing system downtime due to cyber-attacks and enabling faster and more effective incident response. These benefits lead to additional technical benefits such as enhanced network resilience, increased operational continuity, and faster recovery times. By proactively identifying and addressing potential issues, minimizing system downtime strengthens the overall stability and reliability of the system, reducing the likelihood of unexpected outages due to cyber-attacks. Effective monitoring and rapid response mechanisms allow for quicker restoration of system functionality in case of failures, minimizing the impact of any downtime that does occur due to cyber-attacks. Reduced downtime also helps prevent data loss by ensuring consistent system operation and reducing the risk of corruption during unexpected outages. Monitoring system performance during uptime enables the identification of bottlenecks and potential issues, allowing for proactive optimization and improved overall system efficiency. With a robust system that minimizes downtime, entities can more easily scale operations and adapt to changing demands without significant disruptions.

Further, quarantining malicious network packets, such as malware, prevents further infections of network and system components by the malware. By containing the malicious data packet, the disclosed system facilitates stability across the network and systems. Further, quarantining malicious network packets reduces the likelihood of system disruption and downtime, especially in cases of ransomware. Further, quarantining malicious network packets increases network stability by preventing a cascade of infections and disruptions to critical operations. Further, quarantining malicious network packets provides the opportunity to examine the malicious network packet to understand the nature of the malware and potential vulnerabilities being taken advantage of, which can improve future network security implementations.

In some embodiments, the disclosed system adapts to authenticated changes to the baseline traffic data for each host computing device over time. In some embodiments, the disclosed system may detect any deviation or fluctuation in the network communication traffic pattern of a host computing device and determine whether the deviation corresponds to an expected operational change or a potential security threat. The system dynamically updates the baseline traffic data by incorporating legitimate or expected operational changes, such as authorized software updates.

In this manner, the disclosed system provides practical applications for improving conventional network anomaly detection and mitigation techniques by implementing a dynamic, computer device-level system to proactively detect and mitigate anomalous network activities. Thus, by implementing the disclosed system, the network security of the host computing devices within the organization is increased. In particular, the network security of the host computing devices within the organization is increased because the disclosed system detects malware and other malicious network data packets that correspond to deviations from a baseline traffic data for a given host computing device that would be left undetected by conventional systems because the conventional systems are not configured to establish a baseline traffic data for each individual computing device level and analyze new network traffic against the established baseline traffic data for each computing device. Instead, conventional systems rely on static firewall policies or centralized monitoring that evaluates network traffic at an aggregate, organization-wide level. Further, by implementing the disclosed system, data stored within the host computing devices and data that can be accessed via the host computing devices are secured from malicious network activities of bad actors.

In some embodiments, the disclosed system includes a network interface operably coupled with a processor. The network interface is configured to receive a first set of traffic data with respect to a host computing device, wherein the first set of traffic data comprises indications of inbound and outbound network communications between the host computing device and one or more other computing devices. The processor is configured to parse the received first set of traffic data to identify a first set of network attributes of the received first set of traffic data. The first set of network attributes indicates content and a network path of each traffic data, from among the first set of traffic data, in a network. In some embodiments, parsing the received first set of traffic data comprises extract a header associated with each segment of a given traffic data; extract a field value within each segment of the given traffic data based at least in part upon the header, wherein the field value comprises an indication of a first source network address of the given traffic data, a first destination network address of the given traffic data, or a first port used to communicate the given traffic data; and detect a network packet size associated with the given traffic data. The processor is further configured to generate a baseline traffic data for the host computing device in response to parsing the received first set of traffic data. The generated baseline traffic data indicates a pattern of expected network communication associated with the host computing device. The processor is further configured to detect a current traffic data associated with the host computing device. The processor is further configured to parse the current traffic data to identify a second set of network attributes associated with the current traffic data, wherein the second set of network attributes indicates content and a network path of the current traffic data, in the network. The processor is further configured to evaluate the current traffic data against the generated baseline traffic data to determine whether the current traffic data is malicious. In some embodiments, evaluating the current traffic data against the generated baseline traffic data comprises comparing at least one network attribute from among the first set of network attributes with a counterpart network attribute from among the second set of network attributes and determining whether at least one network attribute from among the first set of network attributes corresponds to the counterpart network attribute from among the second set of network attributes.

In some embodiments, comparing at least one network attribute from among the first set of network attributes with the counterpart network attribute from among the second set of network attributes comprises at least one of verify whether a second source network address of the current traffic data corresponds to one of expected source network addresses specified in the baseline traffic data; verify whether a second destination network address of the current traffic data corresponds to one of expected destination network addresses specified in the baseline traffic data; verify whether a network protocol type associated with the current traffic data corresponds to one of expected network protocol types specified in the baseline traffic data; verify whether a network path associated with the current traffic data corresponds to one of expected network paths specified in the baseline traffic data; verify whether a second port used in the current traffic data corresponds to one of expected ports specified in the baseline traffic data; verify whether a network packet size of the current traffic data is within an expected network packet size range specified in the baseline traffic data; or verify whether a timestamp of communication of the current traffic data is within an expected temporal range specified in the baseline traffic data.

The processor is further configured to determine a number of attributes of the current traffic data that deviate from counterpart attributes of the generated baseline traffic data in response to evaluating the current traffic data against the generated baseline traffic data. The processor is further configured to determine that the number of attributes of the current traffic data that deviate from the counterpart attributes of the generated baseline traffic data is more than a threshold number. In response to determining that the number of attributes of the current traffic data that deviate from the counterpart attributes of the generated baseline traffic data is more than the threshold number, the processor is further configured to invoke a countermeasure protocol comprising classification of the current traffic data as anomalous; drop a network packet associated with the current traffic data from being received at or communicated from the host computing device; and block future traffic from the second source network address associated with the current traffic data.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to detect and mitigate anomalous network packets;

FIG. 2 illustrates an example operational flow of the system of FIG. 1 to detect and mitigate anomalous network packets; and

FIG. 3 illustrates an example flow chart of a method of the system of FIG. 1 to detect and mitigate anomalous network packets.

### DETAILED DESCRIPTION

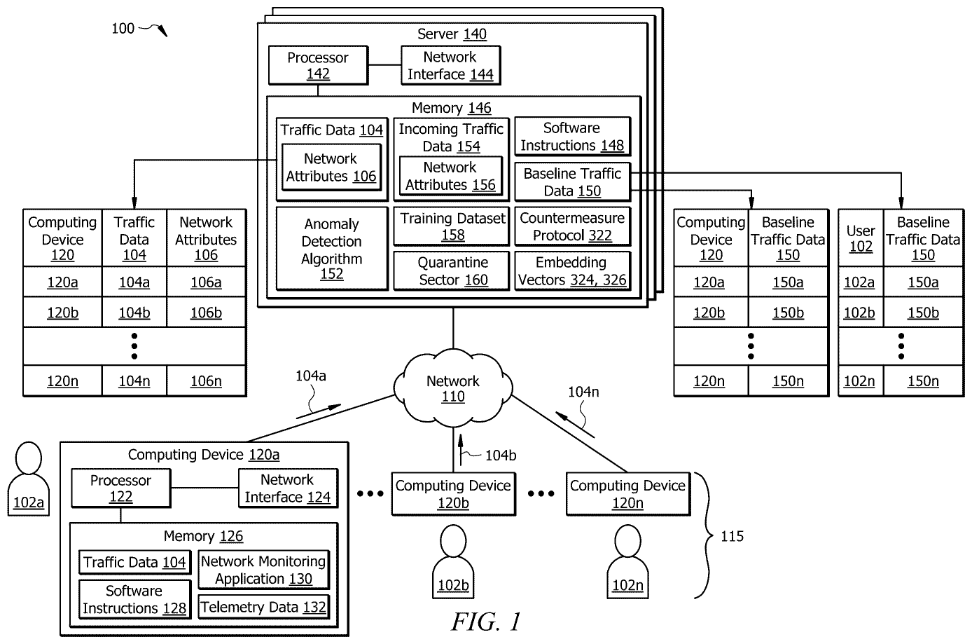

As described above, previous technologies fail to provide efficient and reliable solutions to detect and mitigate anomalous network packets. Embodiments of the present disclosure and its advantages may be understood by referring to FIGS. 1 through 3. FIGS. 1 through 3 are used to describe systems and methods to detect and mitigate anomalous network packets, according to some embodiments.

### System Overview

FIG. 1 illustrates an embodiment of a system 100 that is generally configured to detect and mitigate anomalous network packets. In some embodiments, the system 100 comprises a server 140 communicatively coupled with one or more computing devices 120a-n via a network 110. The network 110 enables the communication among the components of the system 100. Each computing device 120 (e.g., each of computing devices 120a-n) may be used by users 102 to communicate with other devices. The server 140 may be configured to detect and mitigate anomalous network packets (also referred to herein as network data or traffic data). In other embodiments, system 100 may not have all of the components listed and/or may have other elements instead of, or in addition to, those listed above.

In general, the disclosed system 100 provides technological improvements to conventional network anomaly detection techniques. Conventional systems typically implement firewall policies to monitor network traffic at an organization-level network. However, the conventional systems suffer from several drawbacks. For example, the firewall policies are static and solely based on a preconfigured, fixed list of authorized network addresses (e.g., Internet protocol (IP) addresses) and blocked network addresses. Thus, conventional systems fail to detect dynamic new security breaches that are not previously indicated in the static firewall policies. In another example, the conventional systems monitor network traffic at the organization level, as opposed to at each computing device level, and therefore, fail to detect security breaches made from a previously authorized computing device (and/or previously authorized user credentials) within the organization. In other words, the conventional systems monitor the incoming and outgoing communication with respect to the organization's network, rather than monitoring the internal network traffic at the individual computing device level. Thus, if a bad actor gains access to a previously authorized computing device within the organization-whether through stolen user credentials, malware, or insider threats-the conventional systems fail to detect unauthorized activity originating from that device.

The disclosed system 100 is configured to provide a technological solution to these and other technical problems in conventional network anomaly detection techniques. The technical advantages and improvements over the conventional techniques are described below in conjunction with certain embodiments of the disclosed system.

In some embodiments, the disclosed system 100 is configured to implement network anomaly monitoring and detection at the computing device level-which is more granular compared to the conventional systems that implement network traffic monitoring at the organization level. This, in turn, leads to the disclosed system 100 detecting malicious network activity originating from a previously authenticated host computing device 120 and/or authenticated user credential that the conventional systems would fail to detect. The disclosed system 100 establishes a baseline traffic data 150 for each host computing device 120, where the baseline traffic data 150 associated with a given host computing device 120 indicates an expected network communication pattern between the given host computing device and other devices. The disclosed system 100 determines whether any new traffic data 104 of the host computing device 120 deviates from its respective baseline traffic data 150. If it is determined that the new traffic data 154 deviates from the baseline traffic data 150, the disclosed system 100 determines that a bad actor (e.g., an inside traitor) is engaging or conducting a malicious network activity, such as unauthorized network communication, data exfiltration, and the like. The conventional systems would have failed to detect such malicious activity because of their preconfigured firewall policy assuming that the host computing device 120 and/or the user credential used to access that host computing device 120 is/are trusted.

In some embodiments, the disclosed system 100 adapts to authenticated changes to the baseline traffic data 150 for each host computing device 120 over time. In some embodiments, the disclosed system 100 may detect any deviation or fluctuation in the network communication traffic pattern of a host computing device 120 and determine whether the deviation corresponds to an expected operational change or a potential security threat. The system 100 dynamically updates the baseline traffic data 150 by incorporating legitimate expected operational changes, such as authorized software updates.

In this manner, the disclosed system 100 provides technical improvements to the conventional network anomaly detection and mitigation techniques by implementing a dynamic, computer device-level system to proactively detect and mitigate anomalous network activities. Thus, by implementing the disclosed system 100, the network security of the host computing devices is increased.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like to implement quantum communication channels. The network 110 may be configured to support any suitable type of communication protocol as would be appreciated by one of ordinary skill in the art.

### Example Computing Device

Each computing device 120 (e.g., each of computing devices 120a-n) may generally be any device that is configured to process data and interact with users. Examples of the computing device 120 include, but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, a keypad, or other appropriate terminal equipment usable by users. The users 102 may use the computing devices 120 to do various operations, such as data processing, data communication, etc.

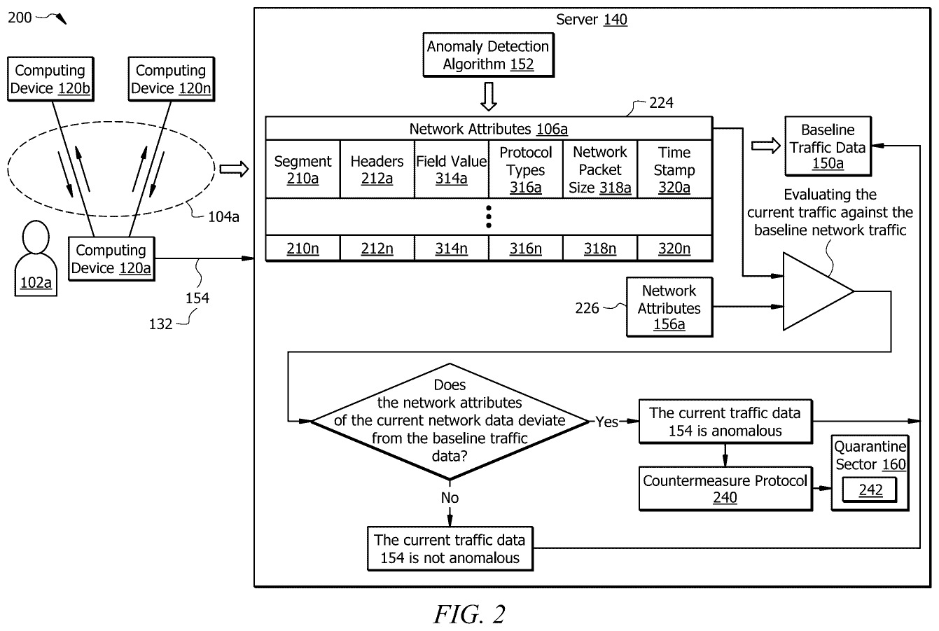

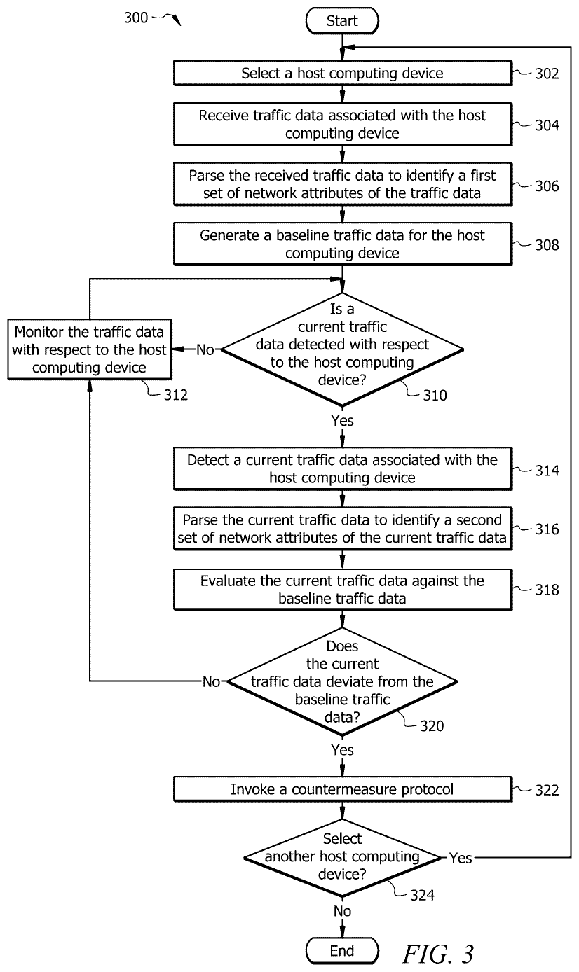

The computing device 120 includes a processor 122 in signal communication with a network interface 124 and a memory 126 configured to perform any of the functions or actions of the computing device 120 described herein. The computing device 120 is configured to communicate with other devices and components of the system 100 via the network 110. Processor 122 comprises one or more processors. The processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 122 may be a programmable logic device, a microcontroller, a microprocessor, or any suitable number and combination of the preceding. The one or more processors are configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations. The processor 122 may register the supply operands to the ALU and store the results of ALU operations. The processor 122 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 128) to perform the operations of the computing device 120 described herein. In this way, processor 122 may be a special-purpose computer designed to implement the functions disclosed herein. In an embodiment, the processor 122 is implemented using logic units, FPGAs, ASICs, DSPs, or any other suitable hardware. The processor 122 is configured to operate as described in FIGS. 1-3. For example, the processor 122 may be configured to perform one or more operations of the operational flow 200 as described in FIG. 2, and one or more operations of the method 300 as described in FIG. 3.

Network interface 124 is configured to enable wired and/or wireless communications. The network interface 124 may be configured to communicate data between the computing device 120 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124.

The memory 126 may be a non-transitory computer-readable medium. The memory 126 may be volatile or non-volatile and may comprise read-only memory (ROM), random-access memory (RAM), ternary content-addressable memory (TCAM), dynamic random-access memory (DRAM), and/or static random-access memory (SRAM). The memory 126 may include one or more of a local database, a cloud database, a network-attached storage (NAS), etc. The memory 126 comprises one or more disks, tape drives, or solid-state drives, and may be used as an overflow data storage device, to store programs when such programs are selected for execution, and to store instructions and data that are read during program execution. The memory 126 may store any of the information described in FIGS. 1-3 along with any other data, instructions, logic, rules, or code operable to implement the function(s) described herein when executed by processor 122. For example, the memory 126 may store software instructions 128, network monitoring application 130, traffic data 104, telemetry data 132, and/or any other data or instructions described herein. The software instructions 128 may comprise any suitable set of instructions, logic, rules, or code operable to execute the processor 122 and perform the functions described herein, such as some or all of those described in FIGS. 1-3. Each of the other computing devices 120b-n includes the same or substantially similar components as the computing device 120a. For brevity, the internal components of the other computing devices 120b-n are not illustrated in FIG. 1.

The network monitoring application 130 may be implemented by the processor 122 executing software instructions 128, and generally configured to monitor traffic data 104 that includes inbound and outbound network communication between the computing device 120a and other devices, such as computing devices 120b-n and server 140. The network monitoring application 130 may be a mobile, web, or software application. The network monitoring application 130 may be installed on the computing devices 120a-n when the server 140 deploys the network monitoring application 130 to the computing devices 120. The network monitoring application 130 may further detect network telemetry data 132 that includes information about the computing device 120 (e.g., type of operating system installed on the computing device 120, memory utilization pattern, processing utilization pattern of the processor 122, network buffer status of the network interface 124, etc.), user information (e.g., login session details, user credentials, user role or entitlement in the organization 112), timestamps of logins, timestamps of each traffic data 104, among others.

In some embodiments, the network monitoring application 130 may be an edge software agent application that is configured to analyze the traffic data 104 and telemetry data 132 to derive network communication patterns and determine whether there is a deviation between the traffic data 104 and the baseline traffic data 150, and provide this information to the server 140. In some embodiments, the network monitoring application 130 provides unprocessed data to the server 140 to analyze and derive insight.

### Example Server

The server 140 generally includes a hardware computer system configured to detect and mitigate anomalous network traffic, according to certain embodiments. In certain embodiments, the server 140 may be implemented by a cluster of computing devices, such as virtual machines in server farms within data centers. For example, the server 140 may be implemented by a plurality of computing devices using distributed computing and/or cloud computing systems in a network. In certain embodiments, the server 140 may be configured to provide services and resources (e.g., data and/or hardware resources as described herein, etc.) to other components and devices.

The server 140 may comprise a processor 142 operably coupled with a network interface 144 and a memory 146. The processor 142 comprises one or more processors. The processor 142 is any electronic circuitry, including, but not limited to, state machines, one or more CPU chips, logic units, cores (e.g., a multi-core processor), FPGAs, ASICS, or DSPs. For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an ALU for performing arithmetic and logic operations. The processor 142 may register the supply operands to the ALU and store the results of ALU operations. The processor 142 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the server 140 described herein. In this way, the processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more operations of the operational flow 200 as described in FIG. 2, and one or more operations of the method 300 as described in FIG. 3.

The network interface 144 is configured to enable wired and/or wireless communications. The network interface 144 may be configured to communicate data between the server 140 and other devices, systems, or domains. For example, the network interface 144 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise read-only memory (ROM), random-access memory (RAM), ternary content-addressable memory (TCAM), dynamic random-access memory (DRAM), and/or static random-access memory (SRAM). The memory 146 may include one or more of a local database, a cloud database, a network-attached storage (NAS), etc. The memory 146 comprises one or more disks, tape drives, or solid-state drives, and may be used as an overflow data storage device, to store programs when such programs are selected for execution, and to store instructions and data that are read during program execution. The memory 146 may store any of the information described in FIGS. 1-3 along with any other data, instructions, logic, rules, or code operable to implement the function(s) described herein when executed by processor 142. For example, the memory 146 may store software instructions 148, baseline traffic data 150, current or new traffic data 154, anomaly detection algorithm 152, training dataset 158, quarantine sector 160, embedding vectors 224 and 226, and/or any other data or instructions. The software instructions 148 may comprise any suitable set of instructions, logic, rules, or code operable to execute the processor 142 and perform the functions described herein, such as some or all of those described in FIGS. 1-3.

The anomaly detection algorithm 152 may be implemented by the processor 142 executing the software instructions 148 and is generally configured to determine whether a given incoming or new traffic data 154 associated with a given computing device 120 is malicious. In some embodiments, the anomaly detection algorithm 152 may comprise a support vector machine, neural networks, random forest, k-means clustering, etc. The anomaly detection algorithm 152 may be implemented by a plurality of neural network layers, convolutional neural network (CNN) layers, Long-Short-Term-Memory (LSTM) layers, Bi-directional LSTM layers, recurrent neural network (RNN) layers, and the like. In some embodiments, the anomaly detection algorithm 152 may implement a natural language processing machine learning algorithm, text processing machine learning algorithm, among others. In some embodiments, the anomaly detection algorithm 152 may be implemented by unsupervised, semi-supervised, or supervised machine learning techniques.

In some embodiments, the anomaly detection algorithm 152 may be trained by a training dataset 158 that includes annotated samples of network data packets and their network attributes are labeled with an indication of anomalous or expected network packets. During training, the anomaly detection algorithm 152 extracts the network attributes from each network packet sample and generates an embedding vector comprising numerical values to represent the associated network packet sample in the vector space. The network attributes may include protocol type, packet size, source and destination network addresses (e.g., IP addresses), network addresses of network nodes (e.g., computing devices 120) along the network path of the given network packet, time of transmission, and payload content. The anomaly detection algorithm 152 determines a distance (e.g., cosine similarity Euclidean distance) between each pair of embedding vectors to determine the similarity between network data packet embeddings and classify them into appropriate clusters in the vector space. Thus, in this manner, a group of non-anomalous network packets may form a dense cluster in the vector space, and another group of non-anomalous network packets may form another dense cluster in the vector space. The anomaly detection algorithm 152 may be trained for each computing device 120 and/or each user credential of user 102 individually to differentiate the training process for traffic data 104 of each computing device 120 and/or each user credential of user 102.

During the testing phase, the anomaly detection algorithm 152 may use the intelligence learned from the training phase to classify the new, unseen traffic data 154 for a given computing device 120 and/or a given user credential as anomalous or non-anomalous. The anomaly detection algorithm 152 may be refined through the backpropagation process by revising the weight and bias values of its neural network to increase the accuracy of its predictions. The anomaly detection algorithm 152 may be deployed as an inference model that continuously generates an embedding vector for any incoming new traffic data 154 in the learned embedding vector space to compare it with the associated baseline traffic data 150. If the embedding vector of the new incoming traffic data 154 deviates from its baseline traffic data 150 (e.g., does not fall within a threshold distance from the center of the cluster of baseline traffic data 150 in the vector space), the anomaly detection algorithm 152 may determine that new traffic data 154 is anomalous or malicious. Otherwise, the anomaly detection algorithm 152 may determine that the incoming traffic data 154 is not anomalous.

The traffic data 104 (for a given host computing device 120) may include indications of inbound and outbound network communications between the given host computing device 120 and one or more other computing devices. The server 140 may receive different sets of traffic data 104a-n from each computing device 120a-n. For example, the server 140 may receive the traffic data 104a from the computing device 120a, the traffic data 104b from the computing device 120b, and traffic data 104n from the computing device 120b. Each set of traffic data 104a-n may include network attributes 106a-n, respectively. The network attributes 106a-n may include protocol type, packet size, source and destination network addresses (e.g., IP addresses), network addresses of network nodes (e.g., computing devices 120) along the network path of the given network packet, time of transmission, and payload content. In some embodiments, each baseline traffic data 150a-n may be associated with a respective computing device 120a-n. In some embodiments, each baseline traffic data 150a-n may be associated with a respective user 102a-n. The pattern of expected network communication indicated by a baseline traffic data 150 may include network protocols of the network communications (e.g., TCP, UDP, DNS, SMB, etc.), the frequency of the network communications, a network path of each network communication within the network 110, among others.

In some embodiments, the anomaly detection process of system 100 may be performed with respect to each user credential and/or each host computing device 120. For example, the disclosed system 100 may establish and maintain separate baseline traffic data 150 for each host computing device 120 and for each user credential associated with a user 102 logged into the host computing device 120. Thus, the network activity is analyzed with respect to associated baseline traffic data 150 to account for scenarios where computing devices 120 are reassigned to different users 102 or where users 102 operate multiple computing devices 120 within the organization 112.

For example, if a computing device 120 is reassigned to a different user 102, the system 100 may dynamically use the traffic baseline data 150 established for the new user 102 for the anomaly detection process, rather than continuing to use the traffic baseline data 150 established for the previous user 102. In another example, if a user 102 operates multiple computing devices 120, the system 100 may use the associated baseline traffic data 150 established for that user 102 for every instance when the user 102 uses user credentials to access the host computing devices 120. Thus, the network anomaly detection and mitigation process may be user specific and/or computing device specific to reduce false positive detections of legitimate network activities. Therefore, the baseline traffic data 150 for each user 102 and/or each computing device 120 may act as a network activity fingerprint for a given user 102 and/or given computing device 120. The conventional systems are not configured to implement such user-specific and/or computing device-specific network anomaly detection and mitigation process because of their static firewall policies.

### Operational Flow for Detecting Anomalous Network Traffic

FIG. 2 illustrates an example operational flow 200 of system 100 for detecting anomalous network traffic, according to some embodiments. The server 140 may perform similar operations of the operational flow 200 for each computing device 120a-n and/or each user 102a-n. In the example of FIG. 2, the operations are described with respect to computing device 120a and/or user 102a.

### Establishing a Baseline Traffic Data

In operation, the operational flow 200 may begin when the server 140 receives the network data 104a from the host computing device 120a and/or user 102a (e.g. via the network monitoring application 130). For example, the network monitoring application 130 may monitor the incoming and outgoing network packets to and from the computing device 120a over time and provide this information to the server 140, continuously, periodically (e.g., every second, every minute, every day), or on demand. The traffic data 104 may include multiple network packets, each associated with specific network attributes that describe the pattern of network communications associated with the computing device 120a.

In response to receiving the traffic data 104a, the server 140 (e.g., via the anomaly detection algorithm 152) may parse the traffic data 104a to extract and identify the network attributes 106a of the traffic data 104a. The network attributes 106a may indicate content and a network path of each traffic data 104a in the network 110. The extracted network attributes 106a may be used to establish a baseline traffic data 150a associated with the host computing device 120a and/or user 102a, where the baseline traffic data 150a represents expected network communication patterns of the host computing device 120a over time. In some embodiments, the anomaly detection algorithm 152 may be implemented by an object-oriented programming language, where the code implementing the anomaly detection algorithm 152 may be configured to treat each attribute 106a of the traffic data 104a as a programming object.

In some embodiments, parsing the traffic data 104a to extract the network attributes 106a may include extracting a header 212a-n associated with each segment 210a-n of a given traffic data 104a, respectively. For example, segment 210a-n of the given traffic data 104a may include different network packets in different communication sessions. The headers 212a-n may include bit fields or text fields where metadata associated with the network packet is stored, such as an indication of a source network address, a destination network address, a transport-layer protocol identifier, a time-to-live (TTL) value, a sequence number, a checksum, or a quality of service (QoS) parameter. The server 140 may extract field values 214a-n from within each segment 210a-n of the given traffic data 104a, based on its associated header 210a-n, respectively. The field values 214a-n may comprise an indication of a source network address (e.g., IP address) of a source computing device 120 from which the given traffic data 104a is communicated, a destination network address (e.g., IP address) of a destination computing device 120 to which the given traffic data 104a is communicated, a port used to communicate the given traffic data 104a.

The server 140 may determine a protocol type 216a-n of each segment 210a-n (each network packet) of the traffic data 104a, respectively. In some examples, the protocol types 210a-n may include a transmission control protocol (TCP), a user datagram protocol (UDP), a domain name system (DNS), a server message block (SMB), among others. The server 140 may detect a network packet size 218a-n associated with each segment 210a-n of given traffic data 104a. The network packet size may indicate the total number of bytes in the associated segment 210a-n. In some embodiments, the server 140 may extract a timestamp 220a-n associated with the communication session of the segments 210an of the traffic data 104a, respectively. The timestamp 220a-n may indicate a time at which the associated network data was transmitted or received.

In response to parsing the traffic data 104a and extracting the network attributes 106a, the server 140 may generate or establish a baseline traffic data 150a for the computing device 120a. The baseline traffic data 108a may indicate a pattern of expected network communication associated with the host computing device 120a. For example, the baseline traffic data 108a may include expected source network addresses that the host computing device 120a is authorized to communicate with, expected destination network addresses for outbound communications of the host computing device 120a, expected protocol types that are typically used by the host computing device 120a, expected network paths associated with the routing of network packets in the network, expected ports used for network services, expected network packet size ranges, and expected temporal ranges for network communication sessions. In some embodiments, the baseline traffic data 108a may be updated dynamically over time to account for legitimate changes in network activity of the host computing device 120a and/or the user 102a.

### Evaluating Incoming Traffic Data Against the Baseline Traffic Data

The server 140 may evaluate incoming or current traffic data 154 associated with the host computing device 120a operated by the user 102a. For example, assume that current traffic data 154 is obtained from the host computing device 120a. For example, the current traffic data 154 may be an inbound network communication with respect to the host computing device 120a. In the same or another example, the current network traffic data 154 may be an outbound network communication with respect to the host computing device 120a.

The server 140 may detect the current traffic data 154 when it is received from the host computing device 120, for example. In response, the server 140 (e.g., via the anomaly detection algorithm 152) may parse the current traffic data 154 to identify (e.g., extract) its network attributes 156. In some embodiments, parsing the current traffic data 154 may be similar to the parsing operation performed on the traffic data 104a, similar to that described above. The network attributes 156 may indicate content and a network path of the current traffic data 154 within the network 110. The server 140 may parse the current traffic data 154 by extracting field values that indicate a source network address (e.g., IP address) of a source computing device from which the current traffic data 154 is communicated, a destination network address (e.g., IP address) of a destination computing device to which the current traffic data 154 is communicated, a port used to communicate the current traffic data 154, a network protocol type associated with the current traffic data 154, a network packet size associated with the current traffic data 154, and a timestamp of communication associated with the current traffic data 154, among others.

The server 140 may compare each network attribute 156 from among the extracted network attributes 156 of the current traffic data 154 with a counterpart network attribute 106a specified in the baseline traffic data 150a. This process may include verifying whether the source network address of the current traffic data 154 corresponds to one of the expected source network addresses specified in the baseline traffic data 150a, whether the destination network address of the current traffic data 154 corresponds to one of the expected destination network addresses specified in the baseline traffic data 150a, whether the port used in the current traffic data 154 corresponds to one of the expected ports specified in the baseline traffic data 150a.

Further, the comparison process may include verifying whether the network protocol type associated with the current traffic data 154 corresponds to one of the expected network protocol types specified in the baseline traffic data 150a, whether the network packet size of the current traffic data 154 is within an expected network packet size range specified in the baseline traffic data 150a, whether the timestamp of communication associated with the current traffic data 154 is within an expected temporal range specified in the baseline traffic data 150a. The server 140 may compare any other network attributes 156 of the current traffic data 154 with the counterpart network attribute 106a specified in the baseline traffic data 150a.

The server 140 may determine a number of network attributes 156a of the current traffic data 154 that deviate from the corresponding network attributes 106a specified in the baseline traffic data 150a. In other words, the server 140 may determine the number of network attributes 156a of the current traffic data 154 that are not found in baseline traffic data 150a (e.g., outside the associated expected network attribute 106 specified in the baseline traffic data 150a). If the number of deviating network attributes 156a is more than a threshold number (e. g, nine out of ten, etc.) or more than a threshold percentage (e.g., more than 90% of total network attributes), the server 140 may classify the current traffic data 154 as anomalous. Otherwise, the server 140 may determine that the current traffic data 154 is not anomalous.

In some embodiments, to evaluate the current network data 154a against the baseline traffic data 150a, the server 140 (e.g., via the anomaly detection algorithm 152) may generate a first embedding vector 224 to represent the network attributes 106a of the baseline traffic data 150 and generate a second embedding vector 226 to represent the network attributes 156a of the current traffic data 154a in the dimensional vector space. To generate the first embedding vector 224, the server 140 may process the network attributes 106a of the baseline traffic data 150a through an embedding function. The embedding function may encode different network attributes 106a into numerical values that are configured to preserve the contextual relationships between the network attributes 106a. The result of the embedding function is the first embedding vector 224 which is a numerical representation of the network attribute 106a in the vector space.

The embedding function may be implemented using the neural network model of the anomaly detection algorithm 152, such as a fully connected neural network, a recurrent neural network, a transformer-based model, and the like which is trained to capture the relationships between network attributes 106a. Similarly, to generate the second embedding vector 226, the server 140 may process the network attributes 156a of the current traffic data 154a through the same embedding function. The embedding function may encode different network attributes 156a into numerical values that are configured to preserve the contextual relationships between the network attributes 156a. The result of the embedding function is the second embedding vector 226 that is a numerical representation of the network attribute 156a in the vector space. In response, the server 140 may perform a vector similarity (e.g., convolution) operation by determining a distance (e.g., Euclidean distance or cosine similarity distance) between the first embedding vector 224 and the second embedding vector 226. If the determined distance is more than a predefined threshold distance (e.g., more than 0.1, 0.2, etc.), the server 140 may determine that the current traffic data 154a deviates from the baseline traffic data 150a beyond an acceptable range. In response, the server 140 may invoke a countermeasure protocol 240 to mitigate a potential security threat.

In some embodiments, the countermeasure protocol 240 may include classifying the current traffic data 154a as anomalous, dropping the network packet 242 associated with (e.g., comprised in) the current traffic data 154a. In particular, dropping the network packet 242 refers to the process by which the server 140 intercepts and prevents the malicious network packet 242 from being processed, forwarded, or reaching its intended destination. Thus, the server 140 stops the malicious network packet 242 in real-time (or close to real-time) after the network packet 242 is evaluated, which mitigates the potential security threat before the malicious network packet 242 can cause harm and infect its destination device and other downstream devices. To drop the network packet 242, for example, the server 140 may remove it from the network interface's buffer and redirect the network packet 242 to be contained in the quarantine sector 160 of the memory 146. By dropping the network packet 242, the malware or malicious code included in the network packet 242 is stopped from being executed and carries out malicious operations, such as data destruction, data exfiltration, deploy ransomware, among others. This reduces the likelihood of compromised data, unauthorized access, and data breaches, and therefore improves the underlying operations of the system.

In some embodiments, the countermeasure protocol 240 may include blocking further (future) network traffic from the source network address of the current traffic data 154a (if the current traffic data 154a is inbound to the host computing device 120a), blocking further network traffic to be sent to other device (if the current traffic data 154a is outbound from the host computing device 120a). In particular, blocking future network traffic refers to the process by which the server 140 modifies firewall policies to prevent future communication with the source network address associated with a detected malicious traffic data 154a. If the current traffic data 154a is identified as inbound and anomalous, the server 140 updates the firewall policies by adding the source network address of the malicious network packet as unauthorized or malicious, and therefore blocking any future inbound traffic from the source network address of the malicious network packet. If the current traffic data 154a is outbound and anomalous, the server 140 modifies the firewall policies to block the host computing device 120a from sending outbound traffic to the device associated with the destination address associated with the malicious network packet. The server 140 may deploy the updated firewall policies to the computing devices 120a as a security update or security patch. By dynamically updating firewall policies, the server 140 proactively prevents recurring security threats from the same malicious network source, rather than reacting to individual malicious packets as in the conventional systems. This reduces the likelihood of compromised data, unauthorized access, and data breaches, and therefore improves the underlying operations of the system.

In some embodiments, the countermeasure protocol 240 may include triggering alert messages that indicates the host computing device 120a is associated with malicious network traffic data 154a, and identifying, isolating, and quarantining data packets 242 associated with the detected malicious traffic data 154a. Quarantining refers to the process by which the server 140 redirects and stores the malicious network packets 242 into a designated quarantine sector 160 of the memory 146 to prevent the network packets 242 from being processed, executed, and/or forwarded to their intended destination. The server 140 may quarantine the malicious data packets 242 in a quarantine sector 160 within the memory 146 of the server 140. The quarantine sector 160 is a memory sector in that any quarantined data packet stored in this quarantine sector 160 is prevented from being processed, forwarded, and/or reaching its intended destination. Thus, any malicious data packet 242 included in the detected malicious traffic data 154a is isolated in the quarantine sector 160 and cannot interact with system resources or other network components.

When the server 140 identifies a malicious network packet 242, the server 140 transfers the malicious network packet 242 into quarantine sector 160, where the packet 242 cannot interact with system resources, modify files, or execute any embedded malicious code. Thus, potential threats are contained and prevented from propagating through the network. The server 140 may determine if the malicious traffic data 154a includes malware, or other security threats based on performing a scan of the quarantined data packets 242. As part of the scan, the server 140 may access a database (stored within the quarantine sector 160) that includes known malicious signatures or behavioral patterns of cyber threats and determine if the contents of the detected malicious traffic data 154a correspond to any known malicious patterns.

If the detected malicious traffic data 154a is determined to include malware or other malicious components, the server 140 may mitigate any identified issue by removing, sanitizing, and/or deleting the malicious components before releasing a sanitized version of the data packet for further processing. In some cases, the server 140 may permanently delete the quarantined data packets 242 to prevent execution of malicious code, data exfiltration, unauthorized access, etc. In this manner, the server 140 mitigates cyber-attacks by physically isolating the detected malicious network packet 242 onto the quarantine sector 160.

By quarantining malicious packets 242, the server 140 prevents malware from spreading to the network and system components. For example, if the malicious packet 242 contains malware or ransomware, quarantining it before its execution, prevents the malware or ransomware from spreading, corrupting files, or exfiltrating data. Additionally, quarantining allows the security teams to analyze the contents of the malicious packet 242 in a controlled environment to understand its behavior, identify vulnerabilities it attempts to take advantage of, and develop improved security measures to combat this and similar cyber-attacks. Furthermore, isolating malicious packets 242 within a quarantine sector 160 reduces the likelihood of system disruption and downtime. If an attack is detected and contained before it reaches critical infrastructure, the system remains operational, minimizing service interruptions. This reduces the likelihood of compromised data, unauthorized access, and data breaches, and therefore improves the underlying operations of the system.

In some embodiments, the server 140 may use the determination of whether the current traffic data 154 is anomalous or non-anomalous as feedback to further refine the boundaries of embedding vectors of the baseline traffic data 150a in the vector space.

In some embodiments, the server 140 may take the telemetry data 132 into account when evaluating each current traffic data 154. For example, in this process, the server 140 may receive the telemetry data 132 along with the current traffic data 154 from the host computing device 120a and analyze the telemetry data 132 to determine additional context for evaluating the current traffic data 154. For example, the server 140 may analyze whether the current traffic data 154 is associated with an active user session based on the login user credentials included in the telemetry data 132. If the user associated with the current traffic data 154 does not have an active login session or does not have the required entitlement, authority, or role within the organization 112, the server 140 may determine that the current traffic data 154 is unauthorized and therefore, malicious.

### Example Method for Detecting and Mitigating Malicious Network Traffic

FIG. 3 illustrates an example flowchart of a method 300 for detecting and mitigating malicious network traffic, according to some embodiments. Modifications, additions, or omissions may be made to method 300. Method 300 may include more, fewer, or other operations. For example, operations may be performed in parallel or in any suitable order. While at times it is discussed that the system 100, computing devices 120, server 140, or components of any of thereof perform some operations, any suitable system or components of the system may perform one or more operations of the method 300. For example, one or more operations of method 300 may be implemented, at least in part, in the form of software instructions 148, 128 of FIG. 1, stored on a tangible non-transitory machine-readable medium (e.g., memory 146, 126 of FIG. 1) that when run by one or more processors (e.g., processor 142, 122 of FIG. 1) may cause the one or more processors to perform operations 302-324.

At operation 302, the server 140 selects a host computing device 120a-n. The server 140 may iteratively select a host computing device 120a-n until no computing device 120 is left for evaluation.

At operation 304, the server 140 receives traffic data 104 associated with the host computing device 120 (e.g., any of the computing devices 120a-n-assuming computing device 120a), similar to that described in FIG. 2.

At operation 306, the server 140 parses the received traffic data 104a to identify a first set of network attributes 106a of the traffic data 104a, similar to that described in FIG. 2.

At operation 308, the server 140 generates a baseline traffic data 150a for the host computing device 120a, similar to that described in FIG. 2.

At operation 310, the server 140 determines whether a current traffic data 154 detected with respect to the host computing device 120a, similar to that described in FIG. 2. If it is determined that the current traffic data 154 is detected with respect to the host computing device 120a, the method 300 proceeds to operation 314. Otherwise, the method 300 proceeds to operation 312.

At operation 312, the server 140 continues to monitor the traffic data with respect to the computing device 120a, similar to that described in FIG. 2.

At operation 314, the server 140 detects the current traffic data 154 associated with the host computing device 120a, similar to that described in FIG. 2.

At operation 316, the server 140 parses the current traffic data 154 to identify a second set of network attributes 156 of the current traffic data 154, similar to that described in FIG. 2.

At operation 318, the server 140 evaluates the current traffic data 154 against the baseline traffic data 150a, similar to that described in FIG. 2.

At operation 320, the server 140 determines whether the current traffic data 154a deviates from the baseline traffic data 150a, similar to that described in FIG. 2. If it is determined that the current traffic data 154a deviates from the baseline traffic data 150a, the method 300 returns to operation 312. Otherwise, the method 300 proceeds to operation 322

At operation 322, the server 140 invokes the countermeasure protocol 240, similar to that described in FIG. 2.

At operation 324, the server 140 determines whether to select another host computing device 120. The server 140 may select another host computing device 120 if at least one host computing device 120 is left for evaluation. If at least one host computing device 120 is left for evaluation, the method 300 may return to operation 302. Otherwise, the method 300 may end. The server(s) 140 may perform the method 300 for multiple host computing devices 120 in parallel. For example, the method 300 may be performed by multiple servers 140 by distributed computing in one or more server farms in one or more data centers.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a network interface configured to receive a first set of traffic data with respect to a host computing device, wherein the first set of traffic data comprises indications of inbound and outbound network communications between the host computing device and one or more other computing devices; and
a processor operably coupled with the network interface, and configured to:
parse the received first set of traffic data to identify a first set of network attributes of the received first set of traffic data, wherein:
the first set of network attributes indicates content and a network path of each traffic data, from among the first set of traffic data, in a network; and
parsing the received first set of traffic data comprises:
extract a header associated with each segment of a given traffic data;
extract a field value within each segment of the given traffic data based at least in part upon the header, wherein the field value comprises an indication of a first source network address of the given traffic data, a first destination network address of the given traffic data, or a first port used to communicate the given traffic data; and
detect a network packet size associated with the given traffic data;
in response to parsing the received first set of traffic data, generate a baseline traffic data for the host computing device, wherein the generated baseline traffic data indicates a pattern of network communication associated with the host computing device; and
detect a current traffic data associated with the host computing device;
parse the current traffic data to identify a second set of network attributes associated with the current traffic data, wherein the second set of network attributes indicates content and a network path of the current traffic data, in the network;
evaluate the current traffic data against the generated baseline traffic data to determine whether the current traffic data is malicious, wherein evaluating the current traffic data against the generated baseline traffic data comprises:
compare at least one network attribute from among the first set of network attributes with a counterpart network attribute from among the second set of network attributes, wherein comparing at least one network attribute from among the first set of network attributes with the counterpart network attribute from among the second set of network attributes comprises at least one of:
verify whether a second source network address of the current traffic data corresponds to one of source network addresses specified in the baseline traffic data;
verify whether a second destination network address of the current traffic data corresponds to one of destination network addresses specified in the baseline traffic data;
verify whether a network protocol type associated with the current traffic data corresponds to one of network protocol types specified in the baseline traffic data;
verify whether a network path associated with the current traffic data corresponds to one of network paths specified in the baseline traffic data;
verify whether a second port used in the current traffic data corresponds to one of ports specified in the baseline traffic data;
verify whether a network packet size of the current traffic data is within a network packet size range specified in the baseline traffic data; or
verify whether a timestamp of communication of the current traffic data is within a temporal range specified in the baseline traffic data; and
determine whether at least one network attribute from among the first set of network attributes corresponds to the counterpart network attribute from among the second set of network attributes;
in response to evaluating the current traffic data against the generated baseline traffic data, determine a number of attributes of the current traffic data that deviate from counterpart attributes of the generated baseline traffic data;
determine that the number of attributes of the current traffic data that deviate from the counterpart attributes of the generated baseline traffic data is more than a threshold number; and
in response to determining that the number of attributes of the current traffic data that deviate from the counterpart attributes of the generated baseline traffic data is more than the threshold number, invoke a countermeasure protocol comprising:
classify the current traffic data as anomalous;
drop a network packet associated with the current traffic data from being received at or communicated from the host computing device; and
block future traffic from the second source network address associated with the current traffic data.

2. The system of claim 1, wherein the countermeasure protocol further comprises triggering an alert message that indicates the host computing device is associated with malicious network traffic.

3. The system of claim 1, wherein the current traffic data comprises an outbound communication with respect to the host computing device.

4. The system of claim 1, wherein the first set of network attributes comprises at least one of:
the header associated with each segment of the given traffic data;
a protocol type associated with the given traffic data;
the network packet size associated with the given traffic data; and
a timestamp of communication associated with the given traffic data.

5. The system of claim 1, wherein the second set of network attributes comprises at least one of:
the header associated with each segment of the current traffic data;
a protocol type associated with the current traffic data;
the network packet size associated with the current traffic data; and
a timestamp of communication associated with the current traffic data.

6. The system of claim 1, wherein the current traffic data comprises an inbound communication with respect to the host computing device.

7. The system of claim 1, wherein the pattern of network communication comprises at least one of:
one or more network protocols of network communication, the one or more network protocols comprising a transmission control protocol (TCP), a user datagram protocol (UDP), a domain name system (DNS), or a server message block (SMB);
a frequency of network communications; and
a network path of each network communication within the network.

8. A method comprising:
receiving a first set of traffic data with respect to a host computing device, wherein the first set of traffic data comprises indications of inbound and outbound network communications between the host computing device and one or more other computing devices;
parsing the received first set of traffic data to identify a first set of network attributes of the received first set of traffic data, wherein:
the first set of network attributes indicates content and a network path of each traffic data, from among the first set of traffic data, in a network; and
parsing the received first set of traffic data comprises:
extracting a header associated with each segment of a given traffic data;
extracting a field value within each segment of the given traffic data based at least in part upon the header, wherein the field value comprises an indication of a first source network address of the given traffic data, a first destination network address of the given traffic data, or a first port used to communicate the given traffic data; and
detecting a network packet size associated with the given traffic data;
in response to parsing the received first set of traffic data, generating a baseline traffic data for the host computing device, wherein the generated baseline traffic data indicates a pattern of network communication associated with the host computing device; and
detecting a current traffic data associated with the host computing device;
parsing the current traffic data to identify a second set of network attributes associated with the current traffic data, wherein the second set of network attributes indicates content and a network path of the current traffic data, in the network;
evaluating the current traffic data against the generated baseline traffic data to determine whether the current traffic data is malicious, wherein evaluating the current traffic data against the generated baseline traffic data comprises:
comparing at least one network attribute from among the first set of network attributes with a counterpart network attribute from among the second set of network attributes, wherein comparing at least one network attribute from among the first set of network attributes with the counterpart network attribute from among the second set of network attributes comprises at least one of:
verifying whether a second source network address of the current traffic data corresponds to one of source network addresses specified in the baseline traffic data;
verifying whether a second destination network address of the current traffic data corresponds to one of destination network addresses specified in the baseline traffic data;
verifying whether a network protocol type associated with the current traffic data corresponds to one of network protocol types specified in the baseline traffic data;
verifying whether a network path associated with the current traffic data corresponds to one of network paths specified in the baseline traffic data;
verifying whether a second port used in the current traffic data corresponds to one of ports specified in the baseline traffic data;
verifying whether a network packet size of the current traffic data is within a network packet size range specified in the baseline traffic data; or
verifying whether a timestamp of communication of the current traffic data is within a temporal range specified in the baseline traffic data; and
determining whether at least one network attribute from among the first set of network attributes corresponds to the counterpart network attribute from among the second set of network attributes;
in response to evaluating the current traffic data against the generated baseline traffic data, determining a number of attributes of the current traffic data that deviate from counterpart attributes of the generated baseline traffic data;
determining that the number of attributes of the current traffic data that deviate from the counterpart attributes of the generated baseline traffic data is more than a threshold number; and
in response to determining that the number of attributes of the current traffic data that deviate from the counterpart attributes of the generated baseline traffic data is more than the threshold number, invoking a countermeasure protocol comprising:
classifying the current traffic data as anomalous;
dropping a network packet associated with the current traffic data from being received at or communicated from the host computing device; and
blocking future traffic from the second source network address associated with the current traffic data.

9. The method of claim 8, wherein the countermeasure protocol further comprises triggering an alert message that indicates the host computing device is associated with malicious network traffic.

10. The method of claim 8, wherein the current traffic data comprises an outbound communication with respect to the host computing device.

11. The method of claim 8, wherein the first set of network attributes comprises at least one of:
the header associated with each segment of the given traffic data;
a protocol type associated with the given traffic data;
the network packet size associated with the given traffic data; and
a timestamp of communication associated with the given traffic data.

12. The method of claim 8, wherein the second set of network attributes comprises at least one of:
the header associated with each segment of the current traffic data;
a protocol type associated with the current traffic data;
the network packet size associated with the current traffic data; and
a timestamp of communication associated with the current traffic data.

13. The method of claim 8, wherein the current traffic data comprises an inbound communication with respect to the host computing device.

14. The method of claim 8, wherein the pattern of network communication comprises at least one of:
one or more network protocols of network communication, the one or more network protocols comprising a transmission control protocol (TCP), a user datagram protocol (UDP), a domain name system (DNS), or a server message block (SMB);
a frequency of network communications; and
a network path of each network communication within the network.

15. A non-transitory computer-readable medium storing instructions that when executed by a processor, cause the processor to:
receive a first set of traffic data with respect to a host computing device, wherein the first set of traffic data comprises indications of inbound and outbound network communications between the host computing device and one or more other computing devices;
parse the received first set of traffic data to identify a first set of network attributes of the received first set of traffic data, wherein:
the first set of network attributes indicates content and a network path of each traffic data, from among the first set of traffic data, in a network; and
parsing the received first set of traffic data comprises:
extracting a header associated with each segment of a given traffic data;
extracting a field value within each segment of the given traffic data based at least in part upon the header, wherein the field value comprises an indication of a first source network address of the given traffic data, a first destination network address of the given traffic data, or a first port used to communicate the given traffic data; and
detecting a network packet size associated with the given traffic data;
in response to parsing the received first set of traffic data, generate a baseline traffic data for the host computing device, wherein the generated baseline traffic data indicates a pattern of network communication associated with the host computing device; and
detect a current traffic data associated with the host computing device;
parse the current traffic data to identify a second set of network attributes associated with the current traffic data, wherein the second set of network attributes indicates content and a network path of the current traffic data, in the network;
evaluate the current traffic data against the generated baseline traffic data to determine whether the current traffic data is malicious, wherein evaluating the current traffic data against the generated baseline traffic data comprises:
comparing at least one network attribute from among the first set of network attributes with a counterpart network attribute from among the second set of network attributes, wherein comparing at least one network attribute from among the first set of network attributes with the counterpart network attribute from among the second set of network attributes comprises at least one of:
verifying whether a second source network address of the current traffic data corresponds to one of source network addresses specified in the baseline traffic data;
verifying whether a second destination network address of the current traffic data corresponds to one of destination network addresses specified in the baseline traffic data;
verifying whether a network protocol type associated with the current traffic data corresponds to one of network protocol types specified in the baseline traffic data;
verifying whether a network path associated with the current traffic data corresponds to one of network paths specified in the baseline traffic data;
verifying whether a second port used in the current traffic data corresponds to one of ports specified in the baseline traffic data;
verifying whether a network packet size of the current traffic data is within a an network packet size range specified in the baseline traffic data; or
verifying whether a timestamp of communication of the current traffic data is within a temporal range specified in the baseline traffic data; and
determining whether at least one network attribute from among the first set of network attributes corresponds to the counterpart network attribute from among the second set of network attributes;
in response to evaluating the current traffic data against the generated baseline traffic data, determine a number of attributes of the current traffic data that deviate from counterpart attributes of the generated baseline traffic data;
determine that the number of attributes of the current traffic data that deviate from the counterpart attributes of the generated baseline traffic data is more than a threshold number; and
in response to determining that the number of attributes of the current traffic data that deviate from the counterpart attributes of the generated baseline traffic data is more than the threshold number, invoke a countermeasure protocol comprising:
classifying the current traffic data as anomalous;
dropping a network packet associated with the current traffic data from being received at or communicated from the host computing device; and
blocking future traffic from the second source network address associated with the current traffic data.

16. The non-transitory computer-readable medium of claim 15, wherein the countermeasure protocol further comprises triggering an alert message that indicates the host computing device is associated with malicious network traffic.

17. The non-transitory computer-readable medium of claim 15, wherein the current traffic data comprises an outbound communication with respect to the host computing device.

18. The non-transitory computer-readable medium of claim 15, wherein the first set of network attributes comprises at least one of:
the header associated with each segment of the given traffic data;
a protocol type associated with the given traffic data;
the network packet size associated with the given traffic data; and
a timestamp of communication associated with the given traffic data.

19. The non-transitory computer-readable medium of claim 15, wherein the second set of network attributes comprises at least one of:
the header associated with each segment of the current traffic data;
a protocol type associated with the current traffic data;
the network packet size associated with the current traffic data; and
a timestamp of communication associated with the current traffic data.

20. The non-transitory computer-readable medium of claim 15, wherein the current traffic data comprises an inbound communication with respect to the host computing device.
